(19) United States
(12) Patent Application Publication
(10) Pub. No.: US 2016/0012456 A1
(43) Pub. Date: Jan. 14, 2016

(54) Product Qualification Engine© [PQE] is a system and computer-implemented method to evaluate and score consumer product readiness, practicality, pricing and viability of the company, or individual, presenting the product, for placement considerations in a retail outlet

(71) Applicant: Timothy Scott Mahaffey, McKinney, TX (US)

(72) Inventor: Timothy Scott Mahaffey, McKinney, TX (US)

(21) Appl. No.: 14/325,492

(22) Filed: Jul. 8, 2014

(51) Int. Cl. G06Q 30/02

(52) U.S. Cl. CPC G06Q 30/0202

(57) ABSTRACT

The Product Qualification Engine© is a system and computer-implemented method that evaluates product readiness, practicality, pricing and viability of the individual/company with a product for placement considerations in various retail outlets. The information is used by the owner product and those looking to sell products in a retail outlet. Based on the selection of acceptable values, a measurement value is assigned and subsequently multiplied by a related data element with its assigned weighting to produce a numerical data element score by category. This system and method fills an industry retail gap to evaluate products with consistent measurements and streamlines the evaluation process for large and small retailers, while identifying gaps for those attempting to place their product in a retail outlet.

The Product Qualification Engine© [PQE] is a system and computer-implemented method to evaluate and score consumer product readiness, practicality, pricing and viability of the company, or individual, presenting the product, for placement considerations in a retail outlet.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This software process and business method relates to the retail industry and individuals, or businesses, making consumer products and inventors of all kinds.

Traditionally, retailer's find products to sell through many hours of research, attending venues where product owners are presenting products, buyer clubs, trade shows, wholesalers, directly from a manufacture, sales representative, or trade show.

Methods to find products vary between large and small retailers. Large retailers include Walmart, JC Penny, Home Depot, etc. . . . while smaller retailers range from regional to local stores.

In 2013 a survey conducted in by Retail Passage, LLC, major retailers can spend approximately 50% of their time researching and approximately 50% listening to product “pitches” by product owners. It was found 30% to 40% of those product owners do not have an understanding of the effort and logistics required to provide product to meet demand of larger retailers, liability insurance requirements, or retail awareness. Buyers are constantly looking at product lines and conducting market research to determine the key brands and styles in the market place. For new products or new vendors who would like to sell to large retailers, only 10-15% are prepared to sell and ship product. Most do not understand the logistics involved to ship to a large retailer and most do not do enough research into the retailer they are selling to.

In the same survey it was found that in addition to the tools used by larger retailers, regional and smaller retailers leverage tools on the Internet, but are challenged with high, unrealistic minimums and often the retailer doesn't receive a response. They can often spend hours, even days, looking for products, depending on the timeline. As an example, they may be looking for a product in May to sell at Christmas and in October for Valentine's Day items. This takes away precious time required to continue to build on their existing customer base. Not surprisingly, more product owners working with smaller retailers are better prepared to meet production demands, have the required liability insurance (less expensive) and have more flexibility in pricing simply based on an more acceptable scale.

The Product Owners, either an individual or business, find it very difficult to get their products in-front of a retailer, let alone accepted. They make cold calls, send emails, follow-up on referrals, and attend trade shows with less success than desired. Often times they lack capital resources for mass marketing to create general appeal.

Smaller product owners spend from 15 to 50% of their time in attempts to get their products place in a retail store. Additionally, lack of general information on this topic, no standard measurement and lack of a process has created a difficult barrier for product owners to have their products in a retail outlet.

According to the United States Small Business Administration, as of 2010 there were over 24 million small businesses. Some of those are service businesses, i.e. lawn care services, CPAs, home cleaning services, etc. . . . , but millions more are creating products. There were no valid statistics found to know how many “products” exists, but this number is in the millions.

In either case, large, regional or small, no common industry process, measurement or method was found to evaluate products objectively, consistently and/or unbiased. Additionally, no standard documentation, process or method was found to help educate what's required to have a product accepted between these two parties.

### BRIEF SUMMARY OF THE INVENTION

The Product Qualification Engine [PQE] is a software process and business method that evaluates and scores consumer product readiness, practicality, pricing and viability of the company, or individual, presenting the product [Product Owner]. The PQE produces a numerical value and scores the Product Owner in four (4) categories (pricing, retail readiness, product production capabilities, and business assessment). The scores (“indicators”) are determined based on the questions answered by the Product Owners and are intended to assist in the objective evaluation of consumer products for retail organizations for placement considerations.

Based on mathematical calculations, scores are generated and aggregated in four (4) data groups with 28 unique data elements. Input is collected from the Product Owner through a web site, or any other software language (i.e. spreadsheets, or other computer language). The information is processed based on algorithms and equations and a numerical value is generated for each category. Scoring is determined based on the Measurement Value (MV) multiplied by the Weighting for each Data Element (DE) within the Data Group (DG). Then all DE scores are aggregated for the DG score to complete the final score.

Based on the selection of the Acceptable Values (AV), a Measurement Value (MV) is assigned and subsequently multiplied by the Data Element (DE) assigned Weighting (W) to product the numerical Data Element (DE) score.

The Product Qualification Engine (PQE) determines consumer product readiness, retail store fit, likelihood of consumer acceptance and viability of the company/person with the product. It is designed to ensure the product is suitable, assist the retail buyer in making buying decisions and educate the Product Owner on corrective steps they should take to ready their product.

This process and method fills an industry retail gap to evaluate products with a consistent measurement and streamlines the evaluation process for large and small Retailers.

### BRIEF DESCRIPTION OF THE SEVERAL VIEWS OF THE DRAWING

A more clear understanding is going to be best summarized by understanding the process flow. Accordingly:

FIG. 1 is a diagram depicting the high level process flow of the Product Qualification Engine (PQE) System & Computer-Implemented Method Components.

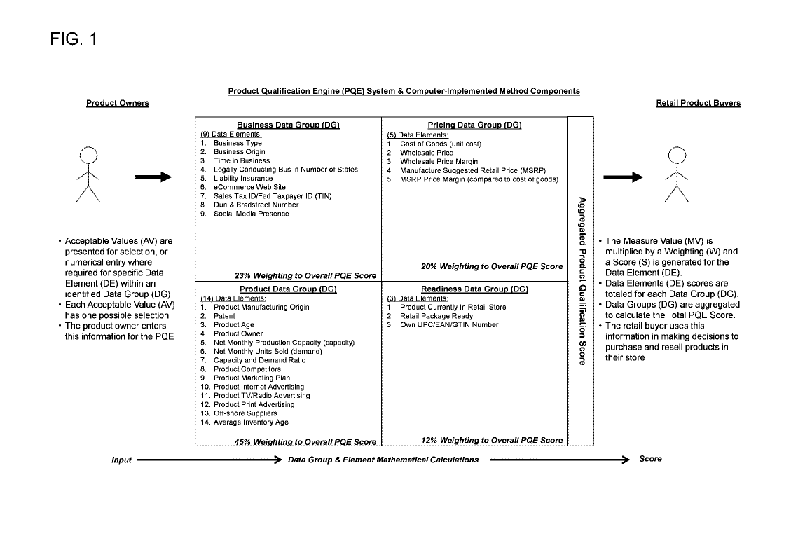

FIG. 2. Is a matrix illustrating the data group, data elements, acceptable values, weighting, possible score and supporting mathematical calculation information.

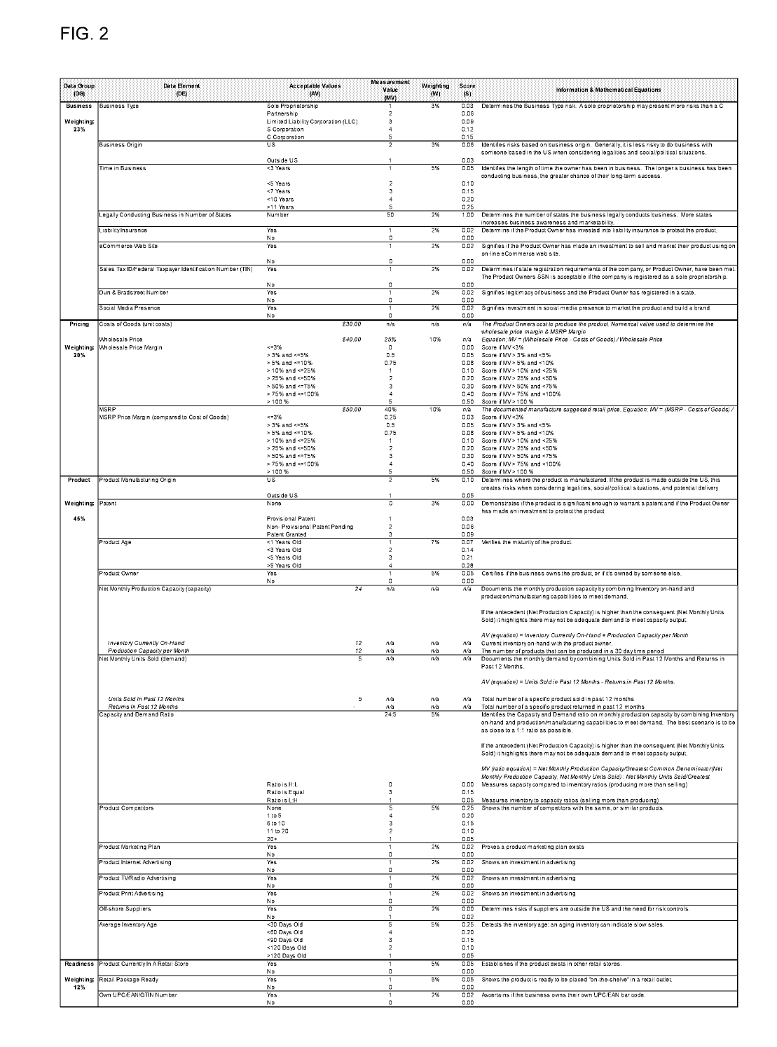

### DETAILED DESCRIPTION OF THE INVENTION

Based on mathematical calculations, scores are generated and aggregated in four (4) data groups with 31 unique data elements. Input is collected from the Product Owner through a web site, or any other software language (i.e. spreadsheets, or other computer language). The information is processed based on algorithms and equations and a numerical value is generated for data group. Scoring is determined based on the Measurement Value (MV) multiplied by the Weighting for each Data Element (DE) within the Data Group (DG). Then all DE scores are aggregated for the DG score to complete the final score.

As input is collected from the owner of the product, the PQE method creates a score based for each response in each data group prior to being aggregated.
1. Acceptable Values (AV) are presented to the Product Owner for selection, or numerical entry where required, via a web site, or any other software language (i.e. spreadsheets, or other computer language) for specific Data Element (DE) within an identified Data Group (DG).
2. Each Acceptable Value (AV) has one possible selection and is associated with a specific Measurement Value (MV).
3. The Measure Value (MV) is multiplied by a Weighting (W) and a Score (S) is generated for the Data Element (DE). (formula; Data Element (DE) Score=Measure Value (MV)*Weighting (MV)
4. Data Elements (DE) scores are totaled for each Data Group (DG).
5. Data Groups (DG) are aggregated to calculate the Total PQE Score.

The four (4) Data Groups (DG) with weighting percentages attributed to the Total PQE Score are as follows:
1. Business with an overall weighting of 23%
2. Pricing with an overall weighting of 20%
3. Product with an overall weighting of 45%
4. Readiness with an overall weighting of 12%

In the Business Data Group (DG), there are nine (9) Data Elements (DE); Business Type, Business Origin, Time in Business, Legally Conducting Business in Number of States, Liability Insurance, eCommerce Web Site, Sales Tax ID/Federal Taxpayer Identification Number (TIN), Dun & Bradstreet Number and Social Media Presence. The overall weighting of these combined Data Elements is 23%.
1. Business Type determines the business type risk. For example, a sole proprietorship may present more risks than a C corporation. It has five (5) Acceptable Values (AV) and a Weighting (W) of 3%;
   a. Sole Proprietorship: Measurement Value (MV) of 1 for a Score (S) of 0.03
   b. Partnership: Measurement Value (MV) of 2 for a Score (S) of 0.06
   c. Limited Liability Corporation (LLC): Measurement Value (MV) of 3 for a Score (S) of 0.09
   d. S Corporation: Measurement Value (MV) of 4 for a Score (S) of 0.12
   e. C Corporation: Measurement Value (MV) of 5 for a Score (S) of 0.15
2. Business Origin identifies risks based on business origin. Generally, it is less risky to do business with someone based in the US when considering legalities and social/political situations outside the United States. It has two (2) Acceptable Values (AV) and a Weighting (W) of 3%;
   a. US: Measurement Value (MV) of 2 for a Score (S) of 0.06
   b. Outside US: Measurement Value (MV) of 1 for a Score (S) of 0.03
3. Time in Business identifies the length of time the owner has been in business. The longer a business has been conducting business, the greater chance of their long-term success. It has five (5) Acceptable Values (AV) and a Weighting (W) of 5%;
   a. <3 Years: Measurement Value (MV) of 1 for a Score (S) of 0.05
   b. <5 Years: Measurement Value (MV) of 2 for a Score (S) of 0.10
   c. <7 Years: Measurement Value (MV) of 3 for a Score (S) of 0.15
   d. <10 Years: Measurement Value (MV) of 4 for a Score (S) of 0.20
   e. >11 Years: Measurement Value (MV) of 5 for a Score (S) of 0.25
4. Legally Conducting Business in Number of States determines the number of states the business legally conducts business. More states increases business awareness and marketability. It has one (1) Acceptable Values (AV) and a Weighting (W) of 2%;
   a. 1 to 50: Measurement Value (MV) is the Acceptable Value (AV) Numerical Entry for a Score (S) of that is calculated based on the Measurement Value multiplied by the Weighting (MV*W).
5. Liability Insurance determines if the Product Owner has invested in liability insurance to protect the product. It has two (2) Acceptable Values (AV) and a Weighting (W) of 2%;
   a. Yes: Measurement Value (MV) of 1 for a Score (S) of 0.02
   b. No: Measurement Value (MV) of 0 for a Score (S) of 0.00
6. eCommerce Web Site signifies if the Product Owner has made an investment to sell and market their product using on on-line eCommerce web site. It has two (2) Acceptable Values (AV) and a Weighting (W) of 2%;
   a. Yes: Measurement Value (MV) of 1 for a Score (S) of 0.02
   b. No: Measurement Value (MV) of 0 for a Score (S) of 0.00
7. Sales Tax ID/Federal Taxpayer Identification Number (TIN) determines if state registration requirements of the company, or Product Owner, are complete. The Product Owners SSN is acceptable if the company is registered as a sole proprietorship. It has two (2) Acceptable Values (AV) and a Weighting (W) of 2%;
   a. Yes: Measurement Value (MV) of 1 for a Score (S) of 0.02
   b. No: Measurement Value (MV) of 0 for a Score (S) of 0.00
8. Dun & Bradstreet Number signifies legitimacy of business and the Product Owner has registered in a state. It has two (2) Acceptable Values (AV) and a Weighting (W) of 2%;
   a. Yes: Measurement Value (MV) of 1 for a Score (S) of 0.02
   b. No: Measurement Value (MV) of 0 for a Score (S) of 0.00
9. Social Media Presence signifies investment in social media presence to market the product and build a brand. It has two (2) Acceptable Values (AV) and a Weighting (W) of 2%;
   a. Yes: Measurement Value (MV) of 1 for a Score (S) of 0.02
   b. No: Measurement Value (MV) of 0 for a Score (S) of 0.00

In the Pricing Data Group (DG), there are five (5) Data Elements (DE); Costs of Goods (unit costs), Wholesale Price, Wholesale Price Margin, MSRP (manufacture suggested retail price) and MSRP Price Margin (compared to Cost of Goods). The overall weighting of these combined Data Elements is 20%.
1. Costs of Goods (unit costs) has one (1) Acceptable Values (AV);
   a. Manual Numerical Value Entry: Product Owners cost to produce the product.
   b. The Measurement Value (MV), Weighting (W) and Score (S) are not applicable since this value is used to determine the Wholesale Price Margin.
2. Wholesale Price has one (1) Acceptable Values (AV);
   a. Manual Numerical Value: Product Owners wholesale costs.
   b. The Measurement Value (MV), Weighting (W) and Score (S) are not applicable since this value is used to determine the Wholesale Price Margin.
3. Wholesale Price Margin has eight (8) Acceptable Values (AV) based on the Equation: (Wholesale Price-Costs of Goods)/Wholesale Price and a Weighting (W) of 10%;
   a. <=3%: Measurement Value (MV) of 0.0 for a Score (S) of 0.00
   b. >3% and <=5%: Measurement Value (MV) of 0.5 for a Score (S) of 0.05
   c. >5% and <=10%: Measurement Value (MV) of 0.75 for a Score (S) of 0.075
   d. >10% and <=25%: Measurement Value (MV) of 1 for a Score (S) of 0.10
   e. >25% and <=50%: Measurement Value (MV) of 2 for a Score (S) of 0.20
   f. >50% and <=75%: Measurement Value (MV) of 3 for a Score (S) of 0.30
   g. >75% and <=100%: Measurement Value (MV) of 4 for a Score (S) of 0.40
   h. >100%: Measurement Value (MV) of 5 for a Score (S) of 0.50;
4. MSRP (manufacture suggested retail price) has one (1) Acceptable Values (AV);
   a. Manual Numerical Value Entry: Product Owners documented manufacture suggested retail price.
   b. The Measurement Value (MV), Weighting (W) and Score (S) are not applicable since this value is used to determine the MSRP Price Margin.
5. Wholesale Price Margin has eight (8) Acceptable Values (AV) based on the Equation: (MSRP−Costs of Goods)/MSRP and a Weighting (W) of 10%;
   a. <3%: Measurement Value (MV) of 0.25 for a Score (S) of 0.025
   b. >3% and <=5%: Measurement Value (MV) of 0.5 for a Score (S) of 0.05
   c. >5% and <=10%: Measurement Value (MV) of 0.75 for a Score (S) of 0.075
   d. >10% and <=25%: Measurement Value (MV) of 1 for a Score (S) of 0.10
   e. >25% and <=50%: Measurement Value (MV) of 2 for a Score (S) of 0.20
   f. >50% and <=75%: Measurement Value (MV) of 3 for a Score (S) of 0.30
   g. >75% and <=100%: Measurement Value (MV) of 4 for a Score (S) of 0.40
   h. >100%: Measurement Value (MV) of 5 for a Score (S) of 0.50

In the Product Data Group (DG), there are fourteen (14) Data Elements (DE); Product Manufacturing Origin, Patent, Product Age, Product Owner, Net Monthly Production Capacity (capacity), Net Monthly Units Sold (demand), Capacity and Demand Ratio, Product Competitors, Product Marketing Plan, Product Internet Advertising, Product TV/Radio Advertising, Product Print Advertising, Off-shore Suppliers, and Average Inventory Age. The overall weighting of these combined Data Elements is 45%.
1. Product Manufacturing Origin determines where the product is manufactured. If the product is made outside the US, this creates risks when considering legalities, social/political situations, and potential delivery delays to meet inventory requirements. It has two (2) Acceptable Values (AV) and a Weighting (W) of 5%;
   a. US: Measurement Value (MV) of 2 for a Score (S) of 0.10
   b. Outside US: Measurement Value (MV) of 1 for a Score (S) of 0.05
2. Patent demonstrates if the product is significant enough to warrant a patent and if the Product Owner has made an investment to protect the product. It has four (4) Acceptable Values (AV) and a Weighting (W) of 3%;
   a. None: Measurement Value (MV) of 0 for a Score (S) of 0.00
   b. Provisional Patent: Measurement Value (MV) of 1 for a Score (S) of 0.03
   c. Non-Provisional Patent Pending: Measurement Value (MV) of 2 for a Score (S) of 0.06
   d. Patent Granted: Measurement Value (MV) of 3 for a Score (S) of 0.09
3. Product Age verifies the maturity of the product. It has four (4) Acceptable Values (AV) and a Weighting (W) of 7%;
   a. <1 Years Old: Measurement Value (MV) of 1 for a Score (S) of 0.07
   b. <3 Years Old: Measurement Value (MV) of 2 for a Score (S) of 0.14
   c. <5 Years Old: Measurement Value (MV) of 3 for a Score (S) of 0.21
   d. >5 Years Old: Measurement Value (MV) of 4 for a Score (S) of 0.28
4. Product Owner certifies if the business owns the product, or if its owned by someone else. It has two (2) Acceptable Values (AV) and a Weighting (W) of 5%;
   a. Yes: Measurement Value (MV) of 1 for a Score (S) of 0.05
   b. No: Measurement Value (MV) of 0 for a Score (S) of 0.00
5. Net Monthly Production Capacity documents the monthly production capacity by combining Inventory On-Hand and Production/Manufacturing Capabilities to meet demand. It has three (3) Acceptable Values (AV) and no Weighting (W);
   a. Inventory Currently On-Hand: Manual Numerical Value Entry, current inventory on-hand with the product owner.
   b. Production Capacity per Month: Manual Numerical Value Entry, the number of products that can be produced in a 30 day time period
   c. Calculated Numerical Value: Inventory Currently On-Hand+Production Capacity per Month
   d. The Measurement Value (MV), Weighting (W) and Score (S) are not applicable since this value is used to determine the Capacity and Demand Ratio.
6. Net Monthly Units Sold (for demand) documents the monthly demand by combining Units Sold in past 12 months and Returns in past 12 months. It has three (3) Acceptable Values (AV) and no Weighting (W) or Score (5),
   a. Units Sold In Past 12 Months: Manual Numerical Value Entry, the total number of a specific product sold in past 12 months
   b. Returns In Past 12 Months: Manual Numerical Value Entry, the total number of a specific product returned in past 12 months
   c. Calculated Numerical Value: Units Sold in Past 12 Months−Returns in Past 12 Months.
   d. The Measurement Value (MV), Weighting (W) and Score (S) are not applicable since this value is used to determine the Capacity and Demand Ratio.
7. Capacity and Demand Ratio Identifies the Capacity and Demand ratio on monthly production capacity by combining Inventory on-hand and production/manufacturing capabilities to meet demand. The best scenario is to be as close to a 1:1 ratio as possible. If the antecedent (Net Production Capacity) is higher than the consequent (Net Monthly Units Sold) it highlights there may not be adequate demand to meet capacity output It has three (3) Acceptable Values (AV) and a Weighting (W) of 5%;
   a. Ratio is H:L: Measurement Value (MV) of 0 for a Score (S) of 0.00
      i. Measures capacity to demand ratios—“producing more than selling”
   b. Ratio is Equal: Measurement Value (MV) of 3 for a Score (S) of 0.15
   c. Ratio is L:H: Measurement Value (MV) of 3 for a Score (S) of 0.05
      i. Measures capacity to demand ratios—“selling more than producing”
   d. Ratio Equation: Net Monthly Production Capacity/Greatest Common Denominator(Net Monthly Production Capacity, Net Monthly Units Sold):Net Monthly Units Sold/Greatest Common Denominator(Net Monthly Units Sold, Net Monthly Production Capacity)
8. Product Competitors shows the number of competitors with the same or similar products. It has five (5) Acceptable Values (AV) and a Weighting (W) of 5%;
   a. None: Measurement Value (MV) of 5 for a Score (S) of 0.25
   b. 1 to 5: Measurement Value (MV) of 4 for a Score (S) of 0.20
   c. 6 to 10: Measurement Value (MV) of 3 for a Score (S) of 0.15
   d. 11 to 20: Measurement Value (MV) of 2 for a Score (S) of 0.10
   e. 20+: Measurement Value (MV) of 1 for a Score (S) of 0.05
9. Product Marketing Plan proves a product marketing plan exists. It has two (2) Acceptable Values (AV) and a Weighting (W) of 2%;
   a. Yes: Measurement Value (MV) of 1 for a Score (S) of 0.02
   b. No: Measurement Value (MV) of 0 for a Score (S) of 0.00
10. Product Internet Advertising shows an investment in advertising. It has two (2) Acceptable Values (AV) and a Weighting (W) of 2%;
   a. Yes: Measurement Value (MV) of 1 for a Score (S) of 0.02
   b. No: Measurement Value (MV) of 0 for a Score (S) of 0.00
11. Product TV/Radio Advertising shows an investment in advertising. It has two (2) Acceptable Values (AV) and a Weighting (W) of 2%;
   a. Yes: Measurement Value (MV) of 1 for a Score (S) of 0.02
   b. No: Measurement Value (MV) of 0 for a Score (S) of 0.00
12. Product Print Advertising shows an investment in advertising. It has two (2) Acceptable Values (AV) and a Weighting (W) of 2%;
   a. Yes: Measurement Value (MV) of 1 for a Score (S) of 0.02
   b. No: Measurement Value (MV) of 0 for a Score (S) of 0.00
13. Off-shore Suppliers determines risks if suppliers are outside the US and the need for risk controls. It has two (2) Acceptable Values (AV) and a Weighting (W) of 2%;
   a. Yes: Measurement Value (MV) of 0 for a Score (S) of 0.00
   b. No: Measurement Value (MV) of 1 for a Score (S) of 0.02
14. Average Inventory Age detects the inventory age. An aging inventory can indicate slow sales. It has five (5) Acceptable Values (AV) and a Weighting (W) of 5%;
   a. <30 Days Old: Measurement Value (MV) of 5 for a Score (S) of 0.25
   b. <60 Days Old: Measurement Value (MV) of 4 for a Score (S) of 0.20
   c. <90 Days Old: Measurement Value (MV) of 3 for a Score (S) of 0.15
   d. <120 Days Old: Measurement Value (MV) of 2 for a Score (S) of 0.10
   e. >120 Days Old: Measurement Value (MV) of 1 for a Score (S) of 0.05

In the Readiness Data Group (DG), there are three (3) Data Elements (DE); Product Currently In A Retail Store, Retail Package Ready and Own UPC/EAN/GTIN Number. The overall weighting of these combined Data Elements is 12%.
1. Product Currently In A Retail Store establishes if the product has been placed in other retail stores. It has two (2) Acceptable Values (AV) and a Weighting (W) of 5%;
   a. Yes: Measurement Value (MV) of 1 for a Score (S) of 0.05
   b. No: Measurement Value (MV) of 0 for a Score (S) of 0.00
2. Retail Package Ready This demonstrates the product is ready to be placed “on-the-shelve” in a retail outlet. It has two (2) Acceptable Values (AV) and a Weighting (W) of 5%;
   a. Yes: Measurement Value (MV) of 1 for a Score (S) of 0.05
   b. No: Measurement Value (MV) of 0 for a Score (S) of 0.00.
3. Own UPC/EAN/GTIN Number ascertains if the business owns their own UPC/EAN bar code. It has two (2) Acceptable Values (AV) and a Weighting (W) of 2%;
   a. Yes: Measurement Value (MV) of 1 for a Score (S) of 0.02
   b. No: Measurement Value (MV) of 0 for a Score (S) of 0.00.

Use of this information is key for Retailers and Product Owners.

If a Product Owner has generated interest in their product through marketing and advertising, made on-line eCommerce sales, been in business for a substantial period, has a patent, bar codes, and a product “ready to place” in a retail store chances of finding a retail store to purchase and resell their product is very good. The retail buyer, whether in a small, midsized or large retail business, has access to objective information.

This information benefits the Product Owner who may not understand which areas need focus to improve their chances for retail placement. If the indicators uncover values in certain Data Groups and Data Elements, it assists to direct the Product Owner on which area to focus. Without this information, it's ambiguous, costly and time consuming for the Product Owners.

This method, measurements and process has not been available in the industry.

The invention claimed is:

1. A system and computer-implemented method to determine if a consumer product is capable, available, and viable to be sold through consumer retail outlets (through a traditional store, or the Internet) based on pricing points, retail product packaging, practically, and viability of the individual, or business via data collected through a web site, or other computer program based on the software rules. The method and computerized process is comprised of the following steps of: (a) presentation of Acceptable Values (AV) to the company, or individual, who owns a product for selection, or numerical entry where required, for a specific Data Element (DE) within an identified Data Group (DG); (b) assignment of a Measurement Value (MV) based on the selected Acceptable Value (AV) where only one possible MV is viable; (c) the calculation of the Data Element (DE) score by multiplying the Measure Value (MV by its associated Weighting (W) (d) the calculation of the Data Group (DG) score by summing the Data Elements (DE) scores; (e) aggregating the Data Groups (DG) to calculate the Total Product Qualification Engine Score.

2. A computer-implemented method for evaluating the viability of the individual, or business, in accordance with claim 1, wherein: said numeric values are derived from nine (9) Data Elements (DE); Business Type, Business Origin, Time in Business, Legally Conducting Business in Number of States, Liability Insurance, eCommerce Web Site, Sales Tax ID/Federal Taxpayer Identification Number (TIN), Dun & Bradstreet Number and Social Media Presence.

3. A computer-implemented method for evaluating the pricing points of the product, in accordance with claim 1, wherein: said numeric values are derived from five (5) Data Elements (DE); Costs of Goods (unit costs), Wholesale Price, Wholesale Price Margin, MSRP (manufacture suggested retail price) and MSRP Price Margin (compared to Cost of Goods).

4. A computer-implemented method for evaluating the practically of the product, in accordance with claim 1, wherein: said numeric values are derived from fourteen (14) Data Elements (DE); Product Manufacturing Origin, Patent, Product Age, Product Owner, Net Monthly Production Capacity (capacity), Net Monthly Units Sold (demand), Capacity and Demand Ratio, Product Competitors, Product Marketing Plan, Product Internet Advertising, Product TV/Radio Advertising, Product Print Advertising, Off-shore Suppliers, and Average Inventory Age.

5. A computer-implemented method for evaluating the retail product packaging readiness, in accordance with claim 1, wherein: said numeric values are derived from three (3) Data Elements (DE); Product Currently In A Retail Store, Retail Package Ready and Own UPC/EAN/GTIN Number.

6. A system for evaluating pricing points, retail product packaging, practically, and viability of the individual, or business based on numerical considerations in accordance with claim 1.
